(19) United States
(12) Patent Application Publication
(10) Pub. No.: US 2026/0350877 A1
(43) Pub. Date: Nov. 5, 2026

(54) DYNAMICALLY UPDATING STRUCTURED LAYOUTS IN A FREE-FORM GRAPHICAL DESIGN ENVIRONMENT

(71) Applicant: FIGMA, INC., San Francisco, CA (US)

(72) Inventors: Molly LLOYD, Portland, ME (US); Ida Fey BERGSON, Nashville, TN (US)

(21) Appl. No.: 19/197,918

(22) Filed: May 2, 2025

(51) Int. Cl. G06T 11/60

(52) U.S. Cl. CPC G06T 11/60

(57) ABSTRACT

Embodiments of the present disclosure provide techniques for updating structured layouts in a free-form graphical design environment that preserves extant relationships between objects included in a structured layout. An example method generally includes receiving an input identifying one or more new visual assets to add at a specified position in a structured layout rendered in a design environment. One or more conflicting visual assets in the structured layout are identified based on the specified position and dimensional information associated with the one or more new visual assets. Based on identifying the one or more conflicting visual assets, position information within the structured layout for the one or more conflicting visual assets is modified. The one or more new visual assets are inserted into the structured layout at the specified position.

### BACKGROUND

### Field of the Various Embodiments

Embodiments of the present disclosure relate generally to rendering structured layouts in a design environment in a computing system and, more specifically, to techniques for updating structured layouts rendered in a free-form graphical design environment executing on a computing system.

### Description of the Related Art

Graphic design tools generally allow for the creation of visual assets in a design environment. These visual assets may be defined, for example, as vector assets defined in terms of mathematical relationships between different components or raster assets defined in terms of absolute pixel locations. In some cases, a visual asset may include one or more containers, defined in the vector space, in which raster assets (e.g., images) can be inserted. A visual asset may include any number of visual components, and a visual asset may be defined in terms of relative positioning or other spatial relationships between visual components in the visual asset.

The design environment hosted by a graphic design tool may be a free-form environment in which the positions of visual assets added to a canvas in a design environment can be arbitrarily defined. While free-form design environments allow for graphic designs to be flexibly defined, some graphic designs may be better suited for rendering using structured layouts. Thus, a free-form design environment may also allow for a structured layout to be defined on the canvas in the graphic design. The structured layout may be a container in which visual assets can be inserted and the positioning of the visual assets may be defined in relation to a defined structure, such as a reference position for the container, a number of elements that can be included in different portions (e.g., rows and columns) of the structured layout, or the like.

To modify a structured layout, objects may be inserted into the structured layout at defined locations of the structured layout. When the structured layout is modified, elements within the structured layout are generally moved, resized, and otherwise modified to allow for new objects to be inserted into the structured layout and for extant objects to remain in the structured layout. However, inserting new objects into a structured layout may result in a loss of contextual data in the structured layout. For example, when a new object overlaps in position with an extant object, the extant object may be moved to allow for the new object to be inserted into the structured layout. However, arbitrary transformations applied to the extant object may cause structural relationships between extant objects in the structured layout to be lost. Further modifications to the arrangement of objects in the structured layout may thus be needed to generate an ordering of objects in the structured layout that retains structural relationships, thus using additional computing resources (e.g., processor cycles, memory, power, etc.).

As the foregoing illustrates, what is needed are more effective techniques for modifying structured layouts in a graphic design environment.

### SUMMARY

One embodiment of the present disclosure provides techniques for updating structured layouts in a free-form graphical design environment that preserves extant relationships between objects included in a structured layout. An example method generally includes receiving an input identifying one or more new visual assets to add at a specified position in a structured layout rendered in a design environment. One or more conflicting visual assets in the structured layout are identified based on the specified position and dimensional information associated with the one or more new visual assets. Based on identifying the one or more conflicting visual assets, position information within the structured layout for the one or more conflicting visual assets is modified. The one or more new visual assets are inserted into the structured layout at the specified position.

One technical advantage of the disclosed techniques relative to the prior art is that the disclosed techniques allow for a structured layout to be updated as new objects are added to the structured layout while preserving extant relationships between objects in the structured layout. As discussed herein, a structured layout in a free-form graphical design environment may be associated with a cache or other data structure in which contextual information about the structured layout and the objects contained therein is maintained. This contextual information may include, for example, positional and size information for different containers within the structured layout, information associating different containers with visual assets contained therein, and so on. Using the contextual information, a set of visual assets included in the structured layout that are affected by the addition of a set of new visual assets are identified. Transforms may be generated and applied to the set of affected visual assets so that structural relationships within the structured layout are preserved. By doing so, embodiments of the present disclosure may efficiently allow for the generation and rendering of structured layouts in a free-form graphic design environment when new assets are added to a structured layout. For example, because structural relationships within the structured layout may be preserved, embodiments of the present disclosure may reduce the computational expense involved in repeated modifications to a structured layout that attempt to recover structural relationships between objects when such relationships are broken during modification of the structured layout.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present disclosure.

FIGS. 2A and 2B illustrate an example modification to a structured layout that preserves structural relationships between extant objects in the structured layout, according to some embodiments.

FIG. 3 illustrates example operations for modifying a structured layout to preserve structural relationships between extant objects in the structured layout, according to some embodiments.

FIG. 4 illustrates a network computing system to implement an interactive graphic application platform, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

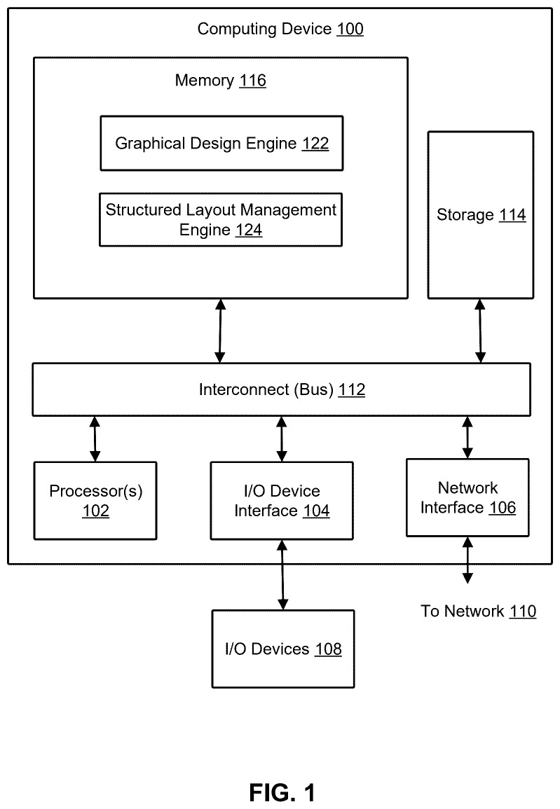

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run graphical design engine 122 and structured layout management engine 124 that resides in a memory 116.

It is noted that the computing device described herein is illustrative and that any other technically feasible configurations fall within the scope of the present disclosure. For example, multiple instances of graphical design engine 122 and/or structured layout management engine 124 could execute on a set of nodes in a distributed and/or cloud computing system to implement the functionality of computing device 100. In another example, graphical design engine 122 and/or structured layout management engine 124 could execute on various sets of hardware, types of devices, or environments to adapt graphical design engine 122 and/or structured layout management engine 124 to different use cases or applications. In a third example, graphical design engine 122 and/or structured layout management engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Graphical design engine 122 and/or structured layout management engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including graphical design engine 122 and/or structured layout management engine 124.

### Example Dynamically Updating Structured Layouts in a Free-Form Graphical Design Environment

Generally, a design environment such as that hosted by graphical design engine 122 allows for the creation of graphical user interfaces and, in some cases, functionality attached to different portions of the graphical user interfaces. These graphical user interfaces may be created for different portions of a workflow executed in an application, by navigating a web site including a plurality of web pages, or the like. Generally, the design environment allows for different design files to be created and visualized in a staging or design environment that is isolated from an execution environment in which the completed graphical user interfaces and associated functionality is eventually to be deployed.

The design environment hosted by graphical design engine 122 may be a free-form design environment in which visual assets can be arranged in any arbitrary manner. While free-form design environments may allow for arbitrary placements of visual assets in a graphic design, structuring the layout of visual assets in the design environment may allow for a more logical arrangement of assets in the graphic design. Thus, the design environment hosted by graphical design engine 122 may allow for a structured layout to be defined and inserted onto a canvas in the design environment. Generally, the structured layout may be a container in which visual assets can be inserted, with the positioning of these visual assets being defined according to a defined structure.

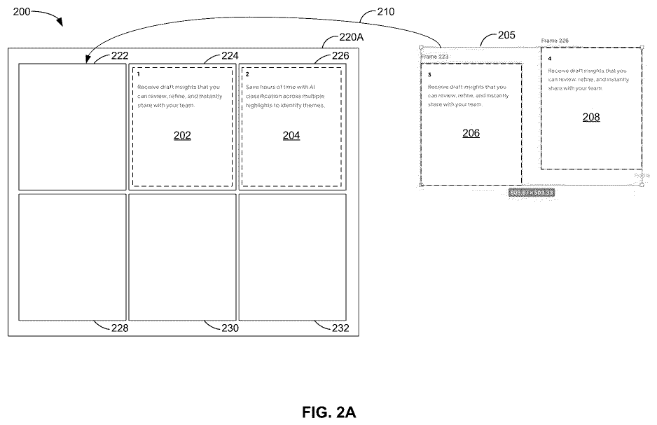

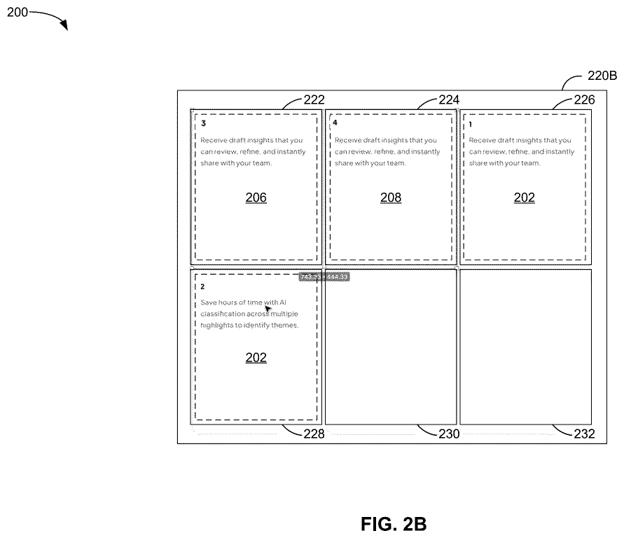

For example, as illustrated in FIG. 2A, a structured layout 220A may be defined in design environment 200 as a grid layout including a number of cells 222, 224, 226, 228, 230, 232. The structured layout 220 may be defined, for example, as a number of cells in width and in height. Each cell 222, 224, 226, 228, 230, 232 may be defined in terms of a reference location (e.g., a spatial coordinate for a defined point of the cell, such as the upper-left corner of the cell) and dimensional information associated with the cell. In some embodiments (though not illustrated), cells can overlap with other cells. In such a case, a cell may be defined by dimensions and other properties indicating that the cell overlaps with another cell. While FIG. 2A and FIG. 2B illustrate a structured layout 220A and a structured layout 220B as a grid including a number of cells, it should be recognized that the structured layout 220A and/or structured layout 220B may be a structure of any arrangement in which visual assets can e inserted and that a cell may be any container defined within the structured layout in which visual assets of any shape can be contained.

Generally, to maintain structural information about a structured layout, structured layout management engine 122 can generate a state cache associated with the structured layout when the structured layout is added to a canvas in design environment 200. The state cache may be, for example, a data structure separate from a file or other data structure in which the structured layout 220 is defined and may enumerate various parameters and state information for the structured layout 220. In an embodiment in which the structured layout 220 is a grid layout, the state cache associated with the structured layout 220 may include information about the number of rows and columns in the structured layout, identifiers of visual assets contained in specific portions (e.g., cells) in the structured layout 220 (if any), size information for different cells or groups of cells, and the like. Because the state cache maintains state information for different cells or other containers within the structured layout, the information stored in the state cache for the structured layout 220 can be used to identify visual assets that are to be modified when new visual assets are added to structured layout 220.

As illustrated in FIG. 2A, a set of new visual assets 205, including visual assets 206 and 208, may be added to structured layout 220A by dragging 210 or otherwise adding the set of new visual assets 205 to a target cell (e.g., cell 222) in structured layout 220A. In this example, structured layout 220A includes visual asset 202 attached to cell 224 and visual asset 204 attached to cell 226, and the remaining cells 222, 228, 230, and 232 may not contain any visual assets. In the state cache discussed above, thus, records defining the cells 222, 228, 230, and 232 may indicate that these cells include no content (e.g., have a null pointer to a visual asset in design environment 200). Records in the state cache defining the cell 224 may include a pointer to visual asset 202 (e.g., a globally unique identifier (GUID) or other value that uniquely identifies visual asset 202 in design environment 200. Finally, records in the state cache defining the cell 226 may include a pointer to visual asset 204.

To add the set of new visual assets 205, structured layout management engine 124 uses information about the number and relative positioning of the set of new visual assets to identify visual assets in the structured layout 220A that conflict with visual assets in the set of new visual assets 205. In some embodiments, structured layout management engine 124 can use reference positions associated with each visual asset in the set of new visual assets 205 to determine the relative positioning of the visual assets in the set of new visual assets 205. The reference position may include, for example, a pixel coordinate of a defined spot for a visual asset, such as the pixel coordinates of the upper left-hand corner of a rectangular shaped visual asset, pixel coordinates of the center or deemed center point of an irregularly shaped visual asset, or the like. Structured layout management engine 124 can determine, for example, that two visual assets are adjacent to each other horizontally if the vertical component of the reference position for two visual assets is located within a threshold vertical distance of each other (e.g., half the height of a container into which the visual assets are to be inserted) and more than a threshold horizontal distance from each other (e.g., more than the width of a container into which the visual assets are to be inserted). In another example, structured layout management engine 124 can determine that two visual assets are adjacent to each other vertically (e.g., stacked) if the vertical component of the reference position for the two visual assets is located more than a threshold vertical distance of each other and less than a threshold horizontal distance from each other. For example, as illustrated in FIG. 2A, based on the locations of the upper left-hand corner coordinate for the visual asset 206 and the visual asset 208, structured layout management engine 124 can determine that the visual asset 206 and visual asset 208 are to be positioned next to each other horizontally and on the same level vertically.

Structured layout management engine 124 uses the determined positioning of the visual assets in the set of new visual assets 205 and the target cell into which the set of new visual assets 205 are dragged 210 to identify conflicting visual assets in the structured layout 220A. In some embodiments, conflicting visual assets may be visual assets that overlap when the visual assets in the set of new visual assets 205 are added to the structured layout 220A, as well as visual assets positioned proximate to overlapping visual assets. To identify visual assets that are conflicting visual assets, structured layout management engine 124 uses the state cache to traverse the structured layout 220A starting from the target cell of the dragging 210. For each visual asset in the set of new visual assets 205, structured layout management engine 124 examines records for the relevant container or cell in the state cache to determine if the container or cell into which a visual asset is to be added is currently empty. If the container or cell into which a visual asset is to be added is currently empty, structured layout management engine 124 can determine that the visual asset can be added to the structured layout 220A without modifying the properties of other containers or cells in structured layout 220A. For example, as illustrated in FIG. 2A, structured layout management engine 124 can determine that the target cell into which visual asset 206 is to be added (e.g., cell 222 in structured layout 220A) is currently empty and thus that visual asset 206 can be added to the structured layout 220A without modifying information associated with other visual assets contained in structured layout 220A.

In some embodiments, conflicting visual assets may be identified based on semantic analysis of textual or other content contained in a visual asset. To determine the semantic meaning of a visual asset, the content contained in a visual asset and (in some embodiments) an image of the visual asset may be input into a generative artificial intelligence model. The generative artificial intelligence model may be prompted to generate a representation (e.g., an embedding representation, a natural language summary, etc.) of the content contained in a visual asset. Structured layout management engine 124 can compare the representations of content in different visual assets to determine whether a visual asset conflicts semantically with another visual asset. If a visual asset conflicts semantically with a new visual asset, the visual asset and other visual assets sharing a semantic relationship with the visual asset may be deemed conflicting assets and may be moved within the structured layout as discussed in further detail below.

If, however, the container or cell into which a visual asset is to be added is occupied by another visual asset, structured layout management engine 124 can determine that a conflict exists between an extant visual asset and a new visual asset. Based on this determination, structured layout management engine 124 marks the extant visual asset as a conflicting visual asset and identifies a set of conflicting visual assets to be moved. Generally, conflicting visual assets may include the extant visual asset in the container or cell into which the new visual asset is to be added as well as other visual assets having a defined, continuous, spatial relationship with the extant visual asset. For example, as illustrated in FIG. 2A, it can be seen that inserting visual asset 208 into structured layout 220A would cause visual asset 208 to overlap with visual asset 202 (which already exists in structured layout 220A). Based on the determined overlap of visual asset 208 and visual asset 202, structured layout management engine 124 can mark visual asset 202 as a conflicting visual asset.

In some embodiments, structured layout management engine 124 can determine that all visual assets in structured layout 200A located after visual asset 202 are conflicting visual assets. In some embodiments, structured layout management engine 124 can identify additional visual assets that are proximate to visual asset 202 to mark as a conflicting visual asset. Assets that are proximate to visual asset 202 may be marked as conflicting visual assets because these assets may generally need to be moved in order to retain spatial relationships or ordering relationships between visual asset 202 and these assets. Generally, a visual asset may be deemed to be proximate to visual asset 202 if the visual asset can be reached by traversing the structured layout in a defined manner (e.g., left-to-right and top-to-bottom, right-to-left and bottom-to-top, etc.) without encountering a container in structured layout 200A that is not associated with a visual asset. In the example illustrated in FIG. 2A, visual asset 204 may be deemed a conflicting asset because visual asset 204 is contained in a cell that is directly adjacent to a cell in which visual asset 202 is contained in structured layout 200A. Because cell 226 is at the end of a row in structured layout 220A, structured layout management engine can wrap around and go to the next row in structured layout 220A to determine whether another visual asset is to be included in a set of conflicting visual assets. In this example, because cell 228 does not contain a visual asset, structured layout management engine 124 can, in some embodiments, determine that no further conflicting visual assets exist.

Generally, when structured layout management engine 124 determines that the position of an extant visual asset in structured layout 220 conflicts with a new visual asset inserted into structured layout 220, structured layout management engine 124 can unlink conflicting visual assets in structured layout 220. To unlink conflicting visual assets from containers or cells in structured layout 220, structured layout management engine 124 can write a null pointer or other null value to records in the state cache associated with cells in which the conflicting visual assets are stored in structured layout 220.

In some embodiments, where the target cell of the dragging 210 is not located in the top row of structured layout 220A (e.g., left-to-right and top-to-bottom layouts), structured layout management engine 124 can determine that visual assets in containers above the target cell and on the same row but left of the target cell are unchanged. Thus, structured layout management engine 124 need not examine these visual assets to determine whether these visual assets are conflicting visual assets. Structured layout management engine 124 can begin traversal of structured layout 220A from the target cell into which the first visual asset in the set of new visual assets 205 is inserted.

Based on the identification of the conflicting visual assets and the locations into which assets in the set of new visual assets 205 are inserted, structured layout management engine 124 can identify the appropriate containers or cells for the conflicting visual assets. Generally, to maintain spatial relationships between conflicting visual assets after the locations of these visual assets are modified, structured layout management engine 124 can shift these visual assets in a direction associated with the intended order in which content is to be viewed in structured layout 220. For example, in a left-to-right and top-to-bottom arrangement, structured layout management engine 124 can adjust the location of the conflicting visual assets by shifting a visual asset rightwards and downwards. If a container at the rightmost location of a row in structured layout 220 is occupied or otherwise associated with a visual asset, structured layout management engine 124 proceeds to examine the leftmost container or cell in the next row of structured layout 220 and moves rightwards until an empty container is found or the end of the row is reached.

After inserting visual asset 206 in cell 222 and visual asset 208 in cell 224, as illustrated in FIG. 2B, structured layout management engine 124 can traverse structured layout 220B to determine the cells into which visual assets 202 and 204 (e.g., the conflicting visual assets) are to be inserted. Because visual asset 202 is located in a cell that is positioned before the cell in which visual asset 204 is contained in structured layout 200A, visual asset 202 may be inserted into structured layout 200B first. In the state cache associated with structured layout 220B, after insertion of visual assets 206 and 208 and removal of conflicting visual assets from the structured layout, cell 226 may be the first cell into which a visual asset can be inserted (e.g., is the first cell for which a corresponding record in the state cache includes a null pointer or other null value for content stored in the cell). Thus, visual asset 202 may be inserted into cell 226. To maintain spatial and/or ordering relationships between visual asset 202 and visual asset 204, structured layout management engine 124 can determine that visual asset 204 is to be inserted into the next cell in structured layout 220B. In this example, thus, structured layout management engine 124 can insert visual asset 204 into cell 228. Structured layout management engine 124 can continue to add visual assets into cells (or containers) in structured layout 220B until no more conflicting assets exist.

In some embodiments, structured layout management engine 124 can use other contextual information to determine the locations at which visual assets are to be inserted into a structured layout. For example, container spanning information may be used to determine whether a visual asset contained in a cell can be inserted into another cell. If a cell (or container) cannot be expanded to a sufficient width such that a visual asset can be inserted into the cell, structured layout management engine 124 can bypass the cell and determine whether the next cell can be expanded sufficiently. For example, suppose that visual asset 202 is sized such that visual asset 202 spans cells 222 and 224 (i.e., is the width of two cells). When the set of new visual assets 205 are added to structured layout 220, cell 226 is the first candidate cell that can contain visual asset 202. However, in this example, because cell 226 is not wide enough or otherwise cannot be expanded to accommodate visual asset 202, structured layout management engine 124 can skip cell 226 and proceed to determine if cell 228 can be used (and expanded) to contain visual asset 202. Since cell 228 can be expanded, structured layout management engine 124 can expand cell 228 in the state cache associated with structured layout 220 and link visual asset 202 to the expanded cell 228 (e.g., by inserting an identifier associated with visual asset 202 to the content field of a record associated with cell 228 in the state cache).

In some embodiments, structured layout management engine 124 can modify the locations of conflicting visual assets to maintain absolute spatial and/or ordering relationships between visual assets in structured layout 220. For example, if absolute spatial and/or ordering relationships between visual assets 202 and 204 is desired, structured layout management engine 124 can be configured to identify a first location at which visual assets 202 and 204 can be moved and maintain a defined relationship (e.g., on the same row or horizontal axis and adjacent to each other). In such a case, structured layout management engine 124 can determine that visual assets 202 and 204 can be moved to cells 228 and 230.

In another example, suppose that a further constraint is defined such that visual asset 204 is to be contained in the rightmost cell (or container) of a row in structured layout 220 and that visual assets 202 and 204 are to be inserted in cells on the same row. In such a case, structured layout management engine 124 can determine visual asset 202 cannot be contained in cell 226 because visual asset 204 would be located on a different row. Further, structured layout management engine 124 can determine visual asset 202 cannot be contained in cell 228 because visual asset 204 would be placed in cell 230, which is not the rightmost cell of a row in structured layout 220. It should be recognized that the foregoing are examples of constraints that may be applied to the locations of visual assets in a structured layout. Other constraints may be defined to condition how extant visual assets are rearranged in a structured layout when new visual assets are added to the visual layout.

In some embodiments, structured layout management engine 124 may use “greedy” techniques to minimize, or at least reduce, the number of visual assets to be rearranged in structured layout 220. In using these “greedy” techniques, structured layout management engine 124 can perform multiple iterations of rearranging visual assets (e.g., when newly rearranged visual assets end up overlapping with other visual assets already contained in structured layout 220) until a final design is generated. This final design may generally (1) include the set of new visual assets in locations in structured layout 220 based on the target cell or container into which the first visual asset in the set of new visual assets is inserted and (2) include extant visual assets in locations shifted relative to the locations of the set of new visual assets in structured layout 220. Shifts or other transformations applied to the locations of these extant visual assets generally preserve spatial and/or ordering relationships between these visual assets. In preserving spatial and/or ordering relationships between visual assets, a first visual asset located before a second visual asset in a pre-modification structured layout (e.g., 220A) may also be located before the second visual asset in a post-modification structured layout (e.g., 220B).

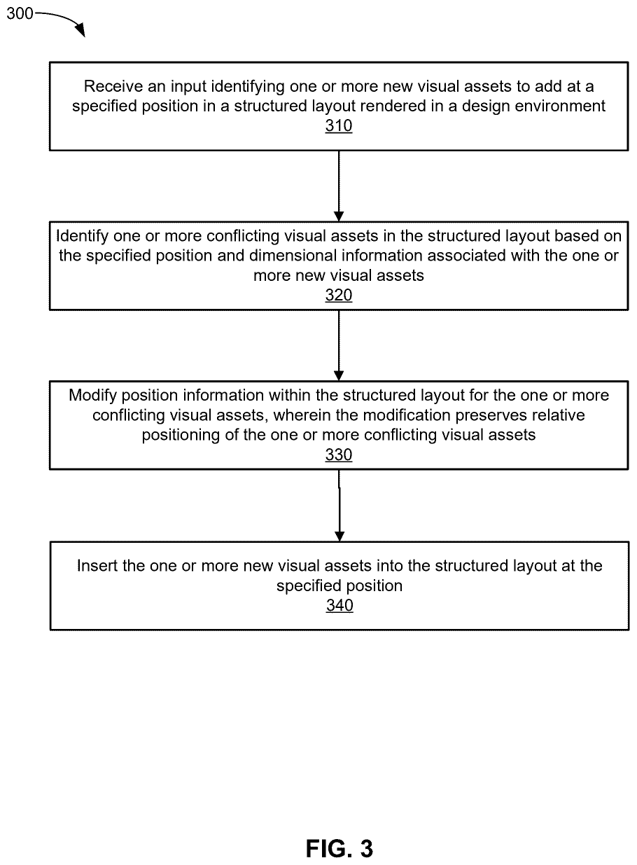

FIG. 3 illustrates example operations 300 for modifying a structured layout to preserve structural relationships between extant objects in the structured layout, according to some embodiments. Operations 300 may be performed, for example, by a computing device on which a graphic design engine and a structured layout management engine that updates structured layouts in a design environment executes, such as a device including graphic design engine 122 and structured layout management engine 124 illustrated in FIG. 1.

As illustrated, operations 300 begin at block 310, where structured layout management engine 124 receives an input identifying one or more new visual assets to add at a specified position in a structured layout rendered in a design environment.

At block 320, structured layout management engine 124 identifies one or more conflicting visual assets in the structured layout based on the specified position and dimensional information associated with the one or more new visual assets.

In some embodiments, to identify the one or more conflicting visual assets in the structured layout, structured layout management engine calculates a reference position in the structured layout for each visual asset of the one or more new visual assets. The reference position may be a pixel location or vertical and horizontal coordinate of a defined point for a visual asset on a canvas in the design environment hosted by graphic design engine 122, a cell index, or the like. Structured layout management engine can identify the one or more conflicting visual assets as one or more extant visual assets in the structured layout having a same position as the reference position for a visual asset of the one or more visual assets. In embodiments in which the reference position is a pixel location, a conflicting visual asset may be identified as an extant visual asset in which the horizontal or vertical coordinate of the reference position is within a threshold distance of a corresponding horizontal or vertical coordinate of the reference position of a new visual asset.

At block 330, structured layout management engine 124 modifies position information within the structured layout for the one or more conflicting visual assets based on identifying the one or more conflicting visual assets. The modification of position information within the structured layout for the one or more conflicting visual assets generally preserves relative positioning of the one or more conflicting visual assets.

In some embodiments, structured layout management engine 124 modifies the position information within the structured layout for the one or more conflicting visual assets by increasing a value of one or more of a horizontal coordinate or a vertical coordinate associated with a reference position for each visual asset of the one or more conflicting visual assets. In some embodiments (e.g., in which visual assets are read in a left-to-right and top-to-bottom order), increasing the value of the horizontal coordinate may move a visual asset rightward in the structured layout and increasing the value of the vertical coordinate may move a visual asset downward in the structured layout.

In some embodiments, the horizontal and vertical coordinate information may include row and column indices for a cell or other container in which a visual asset is contained. Modifying the position information within the structured layout for the one or more conflicting visual assets may involve adjusting (e.g., incrementing or resetting) the row and/or column indices associated with a visual asset.

Generally, structured layout management engine 124 can modify the position within the structured layout for the one or more conflicting visual assets based on a traversal order of content in the structured layout. The preservation of relative position of the one or more conflicting visual assets may include preserving the order in which visual assets are rendered (e.g., relative to an order in which assets are naturally viewed, such as a left-to-right and top-to-bottom order, a right-to-left and top-to-bottom order, etc.), preserving absolute positioning relationships associated with conflicting visual assets, or the like.

In some embodiments, structured layout management engine 124 can modify position information within the structured layout for the one or more conflicting visual assets such that the modification preserves container overlap information associated with the one or more conflicting visual assets after the one or more conflicting visual assets are moved. Container overlap information associated with the one or more conflicting visual assets at original locations of the one or more conflicting visual assets may be removed.

At block 340, structured layout management engine 124 inserts the one or more new visual assets into the structured layout at the specified position.

In some embodiments, state information associated with the structured layout and based on which the one or more conflicting visual assets are identified is maintained in a state cache separate from the structured layout. The state cache may, in some embodiments, include information identifying occupied and unoccupied containers within the structured layout and overlapping containers within the structured layout. Structured layout management engine 124 can, for example, used the state information associated with the structured layout to identify the one or more conflicting assets, identify whether conflicting visual assets can be moved to another cell or other container within the structured layout, determine when cells are to be expanded or contracted, or the like.

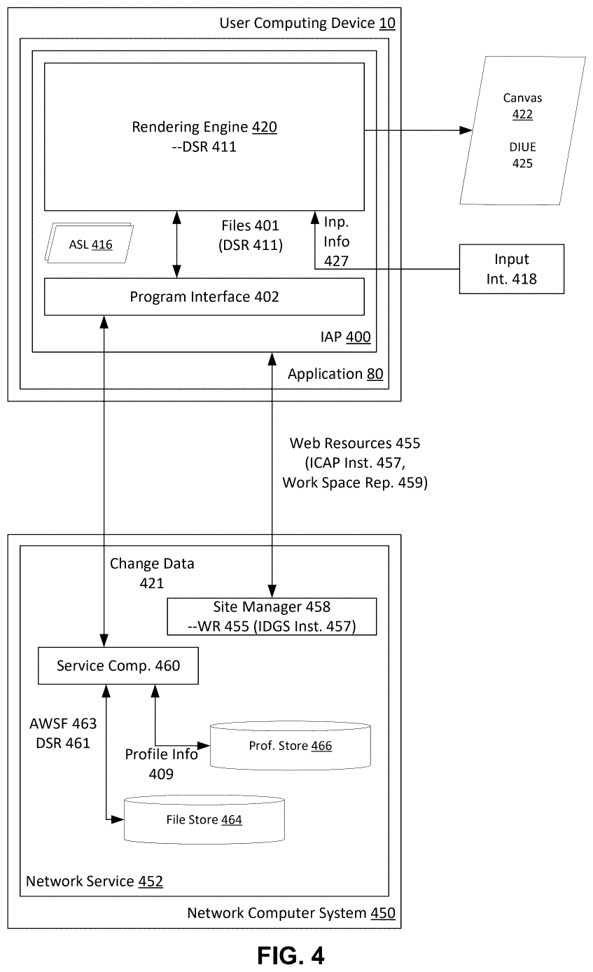

FIG. 4 illustrates a network computing system to implement an interactive application platform on a user computing device, according to some embodiments. A network computing system such as illustrated in FIG. 4 can be implemented using one or more servers which communicate with user computing devices over one or more networks. The network computer system 450 illustrated in FIG. 4 may correspond, for example, to the computing device 100 illustrated in FIG. 1 and can be used to dynamically update and re-render structured layouts when new visual assets are added to a structured layout containing other visual assets.

In some embodiments, the network computing system 450 performs operations to enable an interactive application platform (“IAP 400”) to be implemented on user computing devices 10. In some embodiments, the IAP 400 can be implemented by the user initiating a session (e.g., user accessing a website) to receive programmatic resources of the IAP 400. A browser component executes the programmatic resources to implement the IAP 400, with functionality to receive user input and to render content that is based on or responsive to user input. As described, the IAP 400 is implemented to enable the user to create various types of content, such as interactive graphic designs, art, whiteboard content, program code renderings, presentations, and/or textual content. As further described, the IAP 400 can include logic (“ASL 416”) for implementing one or more application services, where each application service is implemented through the IAP 400 to provide a corresponding set of functionality and user experience. The IAP 400 also implements the application services to share some resources, such as the canvas, workspace file or library of design elements. Further, the IAP 400 enables multiple application services to be used during a given online session and/or with respect to a particular application service.

According to some embodiments, a user of computing device 10 operates web-based application 80 to access a network site, where programmatic resources are retrieved and executed to implement the IAP 400. The web-based application 80 can execute scripts, code and/or other logic (the “programmatic components”) to implement functionality of the IAP 400. In some embodiments, the web-based application 80 can correspond to a commercially available browser, such as GOOGLE CHROME (developed by GOOGLE, INC.) or SAFARI (developed by APPLE, INC.). In some embodiments, the processes of the IAP 400 can be implemented as scripts and/or other embedded code which web-based application 80 downloads from a network site. For example, the web-based application 80 can execute code that is embedded within a webpage to implement processes of the IAP 400. The web-based application 80 can also execute the scripts to retrieve other scripts and programmatic resources (e.g., libraries) from the network site and/or other local or remote locations. By way of example, the web-based application 80 may execute JAVASCRIPT embedded in an HTML resource (e.g., web-page structured in accordance with HTML 5.0 or other versions, as provided under standards published by W3C or WHATWG consortiums). In some embodiments, the rendering engine 420 may utilize graphics processing unit (GPU) accelerated logic, such as provided through WebGL (Web Graphics Library) programs which execute Graphics Library Shader Language (GLSL) programs that execute on GPUs.

The IAP 400 can be implemented as part of a network service, where web-based application 80 communicates with one or more remote computers (e.g., server used for a network service) to execute processes of the IAP 400. The web-based application 80 retrieves some or all of the programmatic resources for implementing the IAP 400 from a network site. The web-based application 80 may also access various types of data sets in providing the IAP 400. The data sets can correspond to files and design libraries (e.g., predesigned design elements), which can be stored remotely (e.g., on a server, in association with an account) or locally. In some embodiments, the network computer system 450 provides a shared design library which the user computing device 10 can use with any of the application services provided through the IAP 400. In this way, the user may initiate a session to implement the IAP 400 for the purpose of creating or editing the workspace file, as rendered on the canvas 422, in accordance with one of multiple collaborative application services of the IAP 400.

In some embodiments, the IAP 400 includes a program interface 402, an input interface 418 and a rendering engine 420. The program interface 402 can include one or more processes which execute to access and retrieve programmatic resources from local and/or remote sources. In an implementation, the program interface 402 can generate, for example, a canvas 422, using programmatic resources which are associated with web-based application 80 (e.g., HTML 5.0 canvas). As an addition or variation, the program interface 402 can trigger or otherwise cause the canvas 422 to be generated using programmatic resources and data sets (e.g., canvas parameters) which are retrieved from local (e.g., memory) or remote sources (e.g., from network service).

The program interface 402 may also retrieve programmatic resources that include an application framework for use with canvas 422. The application framework can include data sets which define or configure, for example, a set of interactive graphic tools that integrate with the canvas 422 and which comprise the input interface 418, to enable the user to provide input to generate or update content rendered on the canvas 422.

According to some embodiments, the input interface 418 can be implemented as a functional layer that is integrated with the canvas 422 to detect and interpret user input. The input interface 418 can, for example, process a user's interaction with an input mechanism (e.g., pointer device, keyboard) of the user computing device, to detect, for example, cursor positioning/movement with respect to the canvas 422, hover input (e.g., pre-selection input), selection input (e.g., clicks or double clicks), shortcuts (e.g., keyboard inputs) and other inputs. In processing a user's interaction with a pointer device, the input interface 418 can use a reference of the canvas 422 to identify a screen location of a user's cursor as the user moves or otherwise interacts with the pointer device. Additionally, the input interface 418 can interpret an input action of the user based on the location of the detected input (e.g., whether the position of the input indicates selection of a tool, an object rendered on the canvas, or region of the canvas), the frequency of the detected input in a given time period (e.g., double-click), and/or the start and end position of an input or series of inputs (e.g., start and end position of a click and drag), as well as various other input types which the user can specify (e.g., right-click, screen-tap, etc.) through one or more input devices. In some embodiments, the input interface 418 can interpret, for example, a series of inputs as a design tool selection (e.g., shape selection based on location of input), as well as inputs to define attributes (e.g., dimensions) of a selected shape. In some embodiments, the input interface 418 can interpret a continuous input (corresponding to a continuous movement of the user's pointer device) as selecting a tool (e.g., shape too) and canvas location where an output of the selected tool is to appear.

In some embodiments, the IAP 400 includes application service logic 416 to enable multiple application services to be utilized during a given user session, where each application service provides the user with a particular functionality and/or user experience. As described by some embodiments, each application service is implemented by the IAP 400 utilizing a corresponding application service logic 416 to configure the interface component 418, rendering engine 420 and/or other components of the IAP 400 to provide the functionality and user experience of the corresponding application service. In this way, the IAP 400 enables the user to operate multiple application services during one online session. Further, the different application services can share resources, including programmatic resources of the IAP 400, such as canvas 422. In this way, each application service can contribute content to and/or utilize features and content provided with the canvas 422 during a given session. Still further, the application services can be implemented as alternative modalities of IAP 400, such that the user can toggle between modes, where each mode provides a particular functionality and user experience. In some embodiments, each application service can utilize a common workspace file associated with the user. By default, a computing device that opens the workspace file can utilize a default application service to access and/or update that workspace file. The user may also switch the mode of operation of the IAP 400 to utilize a different application service to access, use and/or update the workspace file.

The network computing system 450 can include a site manager 458 to manage a website where a set of web-resources 455 (e.g., webpage) are made available for the web-based application 80 of user computing devices 10. The web-resources 455 can include instructions, such as scripts or other logic (“ICAP instructions 457”), which are executable by browsers or web components of user computing devices. The web resources 455 can also include (i) resources that are to be shared as between application services, provided to the user computing devices in connection with the user computing devices utilizing either of the application services, and (ii) application specific resources, which execute on the user computing devices for a particular one of the available application services. The web resources 455 can also include a design library of design elements that is partially or fully shared as between the application services. The library of design elements can enable the user to select predetermined design elements for use on the canvas 422 in connection with the user utilizing either of the application services.

In some variations, once the computing device 10 accesses and downloads the web-resources 455, web-based application 80 executes the IAP instructions 457 to implement functionality as described above. For example, the IAP instructions 457 can be executed by web-based application 80 to initiate the program interface 402 on the user computing device 10. The initiation of the program interface 402 may coincide with the establishment of, for example, a web-socket connection between the program interface 402 and a service component 460 of the network computing system 450.

In some embodiments, the web-resources 455 includes logic which web-based application 80 executes to initiate one or more processes of a program interface 402, causing the IAP 400 to retrieve additional programmatic resources and data sets for implementing functionality as described by examples. The web resources 455 can, for example, embed logic (e.g., JAVASCRIPT code), including GPU accelerated logic, in an HTML page for download by computing devices of users. The program interface 402 can be triggered to retrieve additional programmatic resources and data sets from, for example, the network service 452, and/or from local resources of the computing device 10, in order to implement each of the multiple application services of the IAP 400. For example, some of the components of the IAP 400 can be implemented through webpages that can be downloaded onto the computing device 10 after authentication is performed, and/or once the user performs additional actions (e.g., download one or more pages of the workspace associated with the account identifier). Accordingly, in examples as described, the network computing system 450 can communicate the IAP instructions 457 to the computing device 10 through a combination of network communications, including through downloading activity of web-based application 80, where the IAP instructions 457 are received and executed by web-based application 80.

The computing device 10 can use web-based application 80 to access a website of the network service 452 to download the webpage or web resource. Upon accessing the website, web-based application 80 can automatically (e.g., through saved credentials) or through manual input, communicate an account identifier to the service component 460. In some embodiments, web-based application 80 can also communicate one or more additional identifiers that correlate to a user identifier.

Additionally, in some embodiments, the service component 460 can use the user or account identifier of the user identifier to retrieve profile information 409 from a user profile store 466. As an addition or variation, profile information 409 for the user can be determined and stored locally on the user's computing device 10.

The service component 460 can also retrieve the files of an active workspace (“active workspace files 463”) that are linked to the user account or identifier from a file store 464. The profile store 466 can also identify the workspace that is identified with the account and/or user, and the file store 464 can store the data sets that comprise the workspace. The data sets stored with the file store 464 can include, for example, the pages of a workspace and one or more data structure representations 461 for the design under edit which is renderable from the respective active workspace files.

As an addition or variation, each file can be associated with metadata that identifies the application service that was used to create the particular file. In some embodiments, the metadata identifies the default application service for viewing, utilizing or otherwise updating the application service.

Additionally, in some embodiments, the service component 460 provides a representation 459 of the workspace associated with the user to the web-based application 80, where the representation identifies, for example, individual files associated with the user and/or user account. The workspace representation 459 can also identify a set of files, where each file includes one or multiple pages, and each page including objects that are part of a design interface.

On the user device 10, the user can view the workspace representation through web-based application 80, and the user can elect to open a file of the workspace through web-based application 80. In some embodiments, upon the user electing to open one of the active workspace files 463, web-based application 80 initiates the canvas 422. For example, the IAP 40 can initiate an HTML 5.0 canvas as a component of web-based application 80, and the rendering engine 120 can access one or more data structures representations 411 of content rendered on the canvas 422.

The IAP 400 utilizes application service logic 416 to implement multiple modes of operation, where each mode corresponds to an application service. As described, the application service logic 416 associated with each service application can include instructions and data for configuring the components of IAP 400 to include functionality and features of the corresponding application service. Accordingly, the application service logic 416 can, for example, configure the application framework and/or input interface 418 to differ in form, functionality and/or configuration as between the alternative modes of the IAP 400. Additionally, the type of actions and interactions which the user can perform to register input can vary based on the modes of operation. Still further, the different modes of operation can include different input or user-interface features for the user to select and use for inclusion on the canvas 422. By way of example, when the IAP 400 is operating in a mode for whiteboarding service application, the program interface 402 can provide input features to enable a user to select a design element that is in the form of a “sticky note,” while in an alternative mode for an interactive graphic design service application, the “sticky note feature” is not available. However, in the alternative mode, the user may be able to select anyone of numerous possible shapes or previously designed objects which the user can write textual messages in for display on the canvas 422.

Additionally, the application service logic 416 can configure the operation of the rendering engine 420, such that the functionality and behavior of the rendering engine 420 differs as between different application services. In this way, the rendering engine 420 functions to provide alternative behaviors for different modes of operation, coinciding with the particular service application that is active. By way of example, the configuration of the rendering engine 420 can affect the appearance of the canvas 422, the appearance (e.g., visual attributes) of rendered content elements on the canvas 422, the behavior or representation of user interaction (e.g., whether the user cursor or pointer device is represented on the canvas 422), the type or specific content that is rendered, the physics engine that is used by the rendering engine to represent dynamic events (e.g., the object being moved), what user operations can be performed (e.g., whether select objects can be resized), and the like.

Additionally, each of the application services can utilize a shared library of content elements (e.g., graphic design element), as well as core functionality that enables design elements to be shared and updated between the different application services that are available through the platform. Additionally, the workspace file created and edited through use of one application service can be utilized with the other application service. Moreover, the transition between application services can be seamless—for example, the user computing device 10 can open a workspace file using the first application service (e.g., interactive graphic design application service for UIX design) then seamlessly switch to using the second application service (e.g., whiteboarding application service) with the same file, without closing the workspace file. In some embodiments, each application service enables the user to update the workspace file even while the workspace file is in use by other computing devices (e.g., such as in a collaborative environment). In some embodiments, the user can mode switch the IAP 400 to switch which application service is in use, with each application service utilizing the workspace file.

### EXAMPLE CLAUSES

Various aspects of the present disclosure are described in the following numbered clauses.

1. In some embodiments, a processor-implemented method, comprising: receiving an input identifying one or more new visual assets to add at a specified position in a structured layout rendered in a design environment; identifying one or more conflicting visual assets in the structured layout based on the specified position and dimensional information associated with the one or more new visual assets; modifying position information within the structured layout for the one or more conflicting visual assets, wherein modifying position information within the structured layout for the one or more conflicting visual assets preserves relative positioning of the one or more conflicting visual assets; and inserting the one or more new visual assets into the structured layout at the specified position.

2. The method of clause 1, wherein identifying the one or more conflicting visual assets in the structured layout comprises: calculating a reference position in the structured layout for each visual asset of the one or more new visual assets; and identifying one or more extant visual assets in the structured layout having a same position as the reference position for a visual asset of the one or more visual assets.

3. The method of clause 2, wherein the reference position comprises a horizontal and vertical coordinate of a defined point for a visual asset on a canvas in the design environment.

4. The method of any of clauses 1 through 3, wherein modifying the position information within the structured layout for the one or more conflicting visual assets comprises, for each respective visual asset of the one or more conflicting visual assets, increasing a value of one or more of a horizontal coordinate or a vertical coordinate associated with a reference position for the respective visual asset.

5. The method of clause 4, wherein increasing the value of the horizontal coordinate moves the respective visual asset rightward in the structured layout.

6. The method of any of clauses 4 or 5, wherein increasing the value of the vertical coordinate moves the respective visual asset downward in the structured layout.

7. The method of any of clauses 1 through 6, wherein modifying position information within the structured layout for the one or more conflicting visual assets is performed based on a defined traversal order for content in the structured layout.

8. The method of any of clauses 1 through 7, wherein modifying position information within the structured layout for the one or more conflicting visual assets preserves container overlap information associated with the one or more conflicting visual assets after the one or more conflicting visual assets are moved but removes container overlap information associated with the one or more conflicting visual assets at original locations of the one or more conflicting visual assets.

9. The method of any of clauses 1 through 8, wherein state information associated with the structured layout and based on which the one or more conflicting visual assets are identified is maintained in a state cache separate from the structured layout.

10. The method of clause 9, wherein the state cache includes information identifying occupied and unoccupied containers within the structured layout and overlapping containers within the structured layout.

11. A processing system, comprising: at least one memory having executable instructions thereon; and one or more processors configured to execute the executable instructions to cause the processing system to perform the method of any of clauses 1 through 10.

12. A processing system, comprising: means for performing the method of any of clauses 1 through 10.

13. A non-transitory computer-readable medium having executable instructions stored thereon which, when processed by one or more processors, causes the one or more processors to perform the method of any of clauses 1 through 10.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A processor-implemented method, comprising:
receiving an input identifying one or more new visual assets to add at a specified position in a structured layout rendered in a design environment;
identifying one or more conflicting visual assets in the structured layout based on the specified position and dimensional information associated with the one or more new visual assets;
modifying position information within the structured layout for the one or more conflicting visual assets, wherein modifying position information within the structured layout for the one or more conflicting visual assets preserves relative positioning of the one or more conflicting visual assets; and
inserting the one or more new visual assets into the structured layout at the specified position.

2. The method of claim 1, wherein identifying the one or more conflicting visual assets in the structured layout comprises:
calculating a reference position in the structured layout for each visual asset of the one or more new visual assets; and
identifying one or more extant visual assets in the structured layout having a same position as the reference position for a visual asset of the one or more visual assets.

3. The method of claim 2, wherein the reference position comprises a horizontal and vertical coordinate of a defined point for a visual asset on a canvas in the design environment.

4. The method of claim 1, wherein modifying the position information within the structured layout for the one or more conflicting visual assets comprises, for each respective visual asset of the one or more conflicting visual assets, increasing a value of one or more of a horizontal coordinate or a vertical coordinate associated with a reference position for the respective visual asset.

5. The method of claim 4, wherein increasing the value of the horizontal coordinate moves the respective visual asset rightward in the structured layout.

6. The method of claim 4, wherein increasing the value of the vertical coordinate moves the respective visual asset downward in the structured layout.

7. The method of claim 1, wherein modifying position information within the structured layout for the one or more conflicting visual assets is performed based on a defined traversal order of content in the structured layout.

8. The method of claim 1, wherein modifying position information within the structured layout for the one or more conflicting visual assets preserves container overlap information associated with the one or more conflicting visual assets after the one or more conflicting visual assets are moved but removes container overlap information associated with the one or more conflicting visual assets at original locations of the one or more conflicting visual assets.

9. The method of claim 1, wherein state information associated with the structured layout and based on which the one or more conflicting visual assets are identified is maintained in a state cache separate from the structured layout.

10. The method of claim 9, wherein the state cache includes information identifying occupied and unoccupied containers within the structured layout and overlapping containers within the structured layout.

11. A processing system, comprising:
at least one memory having executable instructions stored thereon; and
one or more processors configured to execute the executable instructions to cause the processing system to:
receive an input identifying one or more new visual assets to add at a specified position in a structured layout rendered in a design environment;
identify one or more conflicting visual assets in the structured layout based on the specified position and dimensional information associated with the one or more new visual assets;
modify position information within the structured layout for the one or more conflicting visual assets, wherein modifying position information within the structured layout for the one or more conflicting visual assets preserves relative positioning of the one or more conflicting visual assets; and
insert the one or more new visual assets into the structured layout at the specified position.

12. The processing system of claim 11, wherein to identify the one or more conflicting visual assets in the structured layout, the one or more processors are configured to cause the processing system to:
calculate a reference position in the structured layout for each visual asset of the one or more new visual assets; and
identify one or more extant visual assets in the structured layout having a same position as the reference position for a visual asset of the one or more visual assets.

13. The processing system of claim 12, wherein the reference position comprises a horizontal and vertical coordinate of a defined point for a visual asset on a canvas in the design environment.

14. The processing system of claim 11, wherein to modify the position information within the structured layout for the one or more conflicting visual assets, the one or more processors are configured to cause the processing system to increase, for each respective visual asset of the one or more conflicting visual assets, a value of one or more of a horizontal coordinate or a vertical coordinate associated with a reference position for the respective visual asset.

15. The processing system of claim 14, wherein:
an increase in the value of the horizontal coordinate moves the respective visual asset rightward in the structured layout, or
an increase in the value of the vertical coordinate moves the respective visual asset downward in the structured layout.

16. The processing system of claim 11, wherein the one or more processors are configured to cause the processing system to modify position information within the structured layout for the one or more conflicting visual assets is performed based on a defined traversal order of content in the structured layout.

17. The processing system of claim 11, wherein the one or more processors are configured to cause the processing system to modify position information within the structured layout for the one or more conflicting visual assets such that container overlap information associated with the one or more conflicting visual assets is preserved after the one or more conflicting visual assets are moved but container overlap information associated with the one or more conflicting visual assets at original locations of the one or more conflicting visual assets is removed.

18. The processing system of claim 11, wherein state information associated with the structured layout and based on which the one or more conflicting visual assets are identified is maintained in a state cache separate from the structured layout.

19. The processing system of claim 18, wherein the state cache includes information identifying occupied and unoccupied containers within the structured layout and overlapping containers within the structured layout.

20. A non-transitory computer-readable medium having executable instructions stored thereon which, when executed by one or more processors, performs an operation comprising:
receiving an input identifying one or more new visual assets to add at a specified position in a structured layout rendered in a design environment;
identifying one or more conflicting visual assets in the structured layout based on the specified position and dimensional information associated with the one or more new visual assets;
modifying position information within the structured layout for the one or more conflicting visual assets, wherein modifying position information within the structured layout for the one or more conflicting visual assets preserves relative positioning of the one or more conflicting visual assets; and
inserting the one or more new visual assets into the structured layout at the specified position.
